(19) United States
(12) Patent Application Publication
(10) Pub. No.: US 2007/0014468 A1
(43) Pub. Date: Jan. 18, 2007

(54) System and method for confidence measures for mult-resolution auto-focused tomosynthesis

(76) Inventors: David Lee Gines, Fort Collins, CO (US); John M. Heumann, Loveland, CO (US); Horst A. Mueller, Loveland, CO (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/179,088

(22) Filed: Jul. 12, 2005

(51) Int. Cl. G06K 9/00; G06K 9/36

(52) U.S. Cl. 382/154; 382/276

(57) ABSTRACT

A method of analyzing image data to determine an appropriate resolution level for image to be generated from the image data. In the method image data can be analyzed to determine a high frequency noise quality and a low frequency noise quality in the image data. These different noise qualities can be used to determine an appropriate resolution for an image to be generated. An apparatus which can execute a method of the invention, is also provided.

### BACKGROUND OF THE INVENTION

It is often desired to construct a cross-sectional view (layer or slice) and/or three-dimensional (3D) view of an object for which actually presenting such views is impossible, such as due to irreparably damaging the object. For example, imaging systems are utilized in the medical arts to provide a view of a slice through a living human's body and to provide 3D views of organs therein. Similarly, imaging systems are utilized in the manufacturing and inspection of industrial products, such as electronic circuit boards and/or components, to provide layer views and 3D views for inspection thereof.

Images are often provided through reconstruction techniques which use multiple two-dimensional (2D) radiographic images. These images may be captured on a suitable film, or electronic detector, using various forms of penetrating radiation, such as X-ray, ultrasound, neutron or positron radiation. The technique of reconstructing a desired image or view of an object (be it a 3D image, a cross-sectional image, and/or the like) from multiple projections (e.g., different detector images) is broadly referred to as tomography. When reconstruction of a cross-sectional image is performed with the aid of a processor-based device (or “computer”), the technique is broadly referred to as computed (or computerized) tomography (CT). In a typical example application, a radiation source projects X-ray radiation through an object onto an electronic sensor array thereby providing a detector image. By providing relative movement between one or more of the object, the source, and the sensor array, multiple views (multiple detector images having different perspectives) may be obtained. An image of a slice through the object or a three-dimensional 3D image of the object may then be approximated by use of proper mathematical transforms of the multiple views. That is, cross-sectional images of an object may be reconstructed, and in certain applications such cross-sectional images may be combined to form a 3D image of the object.

Within the field of tomography, a number of imaging techniques can be used for reconstruction of cross-sectional slices. One imaging technique is known as laminography. In laminography, the radiation source and sensor are moved in a coordinated fashion relative to the object to be viewed so that portions of an object outside a selected focal plane lead to a blurred image at the (see, for example, U.S. Pat. No. 4,926,452). Focal plane images are reconstructed in an analog averaging process. An example of a laminography system that may be utilized for electronics inspection is described further in U.S. Pat. No. 6,201,850 entitled “ENHANCED THICKNESS CALIBRATION AND SHADING CORRECTION FOR AUTOMATIC X-RAY INSPECTION.” An advantage of laminography is that extensive computer processing of ray equations is not required for image reconstruction.

Another imaging technique is known as tomosynthesis. Tomosynthesis is an approximation to laminography in which multiple projections (or views) are acquired and combined. As the number of views becomes large, the resulting combined image generally becomes identical to that obtained using laminography with the same geometry. A major advantage of tomosynthesis over laminography is that the focal plane to be viewed can be selected after the projections are obtained by shifting the projected images prior to recombination. Tomosynthesis may be performed as an analog method, for example, by superimposing sheets of exposed film. Tomosynthesis may, also, be performed as a digital method. In digital tomosynthesis, the individual views are divided into pixels, and digitized and combined via computer software.

Tomosynthesis is of interest in automated inspection of industrial products. For instance, reconstruction of cross-sectional images from radiographic images has been utilized in quality control inspection systems for inspecting a manufactured product, such as electronic devices (e.g., printed circuit boards). Tomosynthesis may be used in an automated inspection system to reconstruct images of one or more planes (which may be referred to herein as “depth layers” or “cross-sections”) of an object under study in order to evaluate the quality of the object (or portion thereof). A penetrating radiation imaging system may create 2-dimensional detector images (layers, or slices) of a circuit board at various locations and at various orientations. Primarily, one is interested in images that lie in the same plane as the circuit board. In order to obtain these images at a given region of interest, raw detector images may be mathematically processed using a reconstruction algorithm.

For instance, a printed circuit board (or other object under study) may comprise various depth layers of interest for inspection. As a relatively simple example, a dual-sided printed circuit board may comprise solder joints on both sides of the board. Thus, each side of the circuit board on which the solder joints are arranged may comprise a separate layer of the board. Further, the circuit board may comprise surface mounts (e.g., a ball grid array of solder) on each of its sides, thus resulting in further layers of the board. The object under study may be imaged from various different angles (e.g., by exposure to radiation at various different angles) resulting in radiographic images of the object, and such radiographic images may be processed to reconstruct an image of a layer (or “slice”) of the object. Thereafter, the resulting cross-sectional image(s) may, in some inspection systems, be displayed layer by layer, and/or such cross-sectional images may be used to reconstruct a full 3D visualization of the object under inspection.

In Laminography, only one layer may be reconstructed at a time. A potential advantage of Tomosynthesis is that many different layers may be reconstructed from a given set of projection (detector) image data. However, only a few of those layers may be of interest, such as those corresponding to the top and bottom surfaces of a circuit board. The location of those layers may be obtained in advance, as must be done in laminography, using an appropriate locating system, or, for Tomosynthesis, may be done after data acquisition using an appropriate analysis of image layers. In the latter case, the selected image may be one that maximizes some constraint, such as image sharpness. An example of such a system is U.S. Published Patent Application No. 2003/0118245, AUTOMATIC FOCUSING OF AN IMAGING SYSTEM. When this analysis is automated using a processing unit, e.g., a digital computer, it is broadly referred to as “auto-focusing.”

### BRIEF DESCRIPTION OF THE DRAWINGS

FIG. 1 is an illustration of an embodiment of a system herein.

FIG. 2 is an example showing auto-focus curves. The auto-focus curves show 4 wavelet resolution levels, as well as the sharpness profile using an alternative method (Sobel) for reference. Each of the curves has been normalized for comparison.

FIG. 3 shows the sharpness profile of an example part, and a smoothed version of the curve. This illustration shows the high frequency component of noise in sharpness profile.

FIG. 4 is a flowchart of an embodiment herein for computing accuracy confidence at different resolution levels.

FIGS. 5A-5D provide an illustration of sample locations used to track the low frequency noise of the sharpness profile.

FIG. 6 is a flowchart showing an embodiment of a method for choosing sample points used to compute reliability score, and for computing reliability scores.

FIG. 7 is a flowchart illustrating an embodiment for determining an accuracy of confidence measure and a reliability score in a multiresolution autofocusing method.

FIGS. 8A-8D is an illustration of steps used in the disclosed method.

### DETAILED DESCRIPTION

In pending U.S. patent application “SYSTEM AND METHOD FOR PERFORMING AUTO-FOCUSED TOMOSYNTHESIS”, (U.S. Published Patent Application No. 20050047636 A1), which is assigned to the same assignee as the assignee of the present application, and which application (20050047636 A1) is incorporated herein by reference in its entirety, a method for auto-focusing is described, that reduces the computational burden of the reconstruction process and image analysis. This is achieved using a “multi-level” or “multi-resolution” algorithm that reconstructs images on a plurality of levels or resolutions. In particular, coarse-resolution representations of the projection (detector) images may be used to generate an initial analysis of the sharpness of layers. Once a collection of layers has been identified as possibly being the sharpest using this analysis, a fine-resolution analysis may be used to refine the estimated location of the sharpest layer. Accordingly, the algorithm may be organized in a hierarchical manner. This approach substantially reduces the computational burden on the processing unit (e.g., computer).

An embodiment herein provides a method for measuring the accuracy and reliability of the multi-resolution auto-focusing method in U.S. Published Patent Application No. 20050047636 A1, and for using this information as feedback in the algorithm itself, for optimization and verification. An embodiment herein addresses a number of issues. First, due to a number of factors, including variations in radiation type used in the imaging system (e.g., X-ray, ultrasound, etc.), imaging noise, the feature size of parts under test, and the imaging algorithms, the multi-resolution auto-focusing algorithm will have different behavior on different resolution levels. For example, the signal-to-noise ratio of images and auto-focus data may be different at different resolution levels. As another example, while one might assume that the highest resolution level gives the best results, in fact the auto-focusing algorithm may give optimal results on a lower resolution level, because the feature size of the part under test matches the imaging operations at that level. This leads to the second potential benefit of an embodiment, further reduction of computational burden. The computational burden can sometimes be further reduced by not visiting higher resolution levels in cases where a lower resolution level offers a satisfactory result. Thus, one significant benefit of an embodiment herein, is the identification of, and quantification of satisfactory results or a good result.

In “SYSTEM AND METHOD FOR PERFORMING AUTO-FOCUSED TOMOSYNTHESIS”, (U.S. Published Patent Application No. 20050047636 A1) a method for auto-focusing is described which reduces the computational burden of the reconstruction process and image analysis. One issue with the approach described in the U.S. Published Patent Application No. 20050047636 A1 is that the algorithm does not provide a method for measuring or quantifying the accuracy of its results. Thus, when the algorithm returns a value for “sharpest layer”, there is no confidence measure associated with that value, so that the user does not know whether the value is reasonable or not. Another benefit of an embodiment herein is that there is a process for recognizing that given several resolution levels to choose from, the highest resolution level may not be the best, as was sometimes assumed in the past. Thus, the accuracy of results may be improved if the best level can be determined, and the computational burden may be reduced, if computations are stopped at that level, where the best level is based on accuracy and reliability factors as described in more detail below.

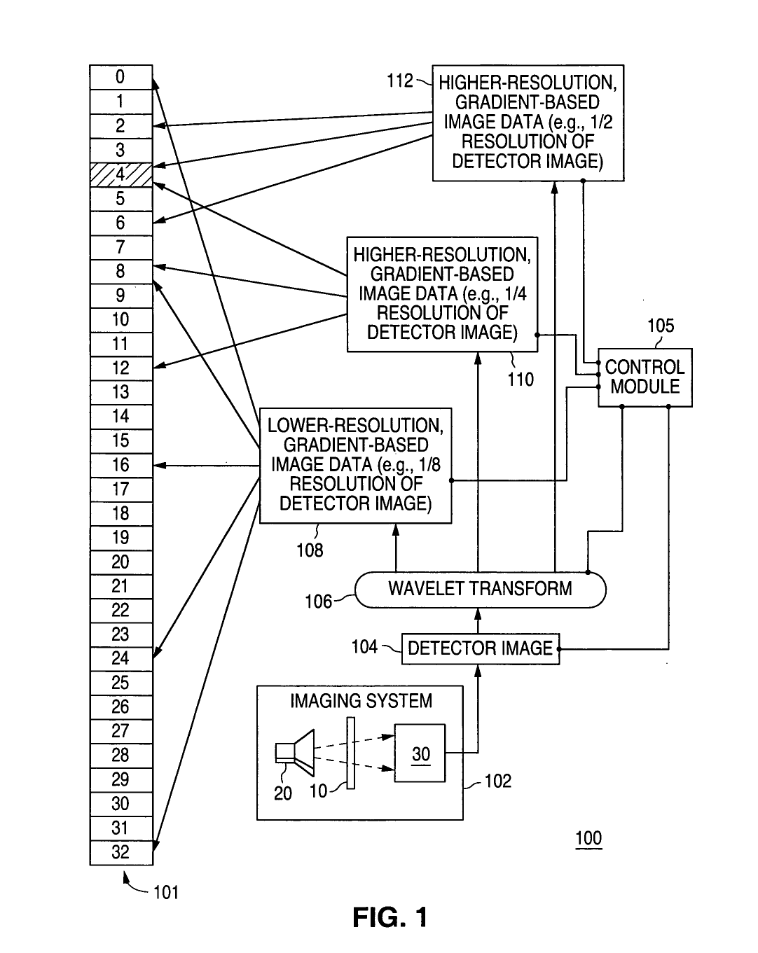

FIG. 1 shows an embodiment herein. According to this embodiment, detector image data is captured for an object under inspection, and the captured image data is used for computing gradient, or sharpness, information for at least one depth layer of the object under inspection without first tomosynthetically reconstructing a full image of the depth layer(s). More specifically, a wavelet transform is computed for the captured detector image, and the wavelet transform is used to perform auto-focusing. It should be recognized that other multi-resolution transforms, and gradient based methods could be used to generate auto-focus curves, or other information, which can be used in an embodiment herein. Indeed, potentially any method that creates a sharpness profile for generating auto-focus curves could be utilized. In one embodiment, herein, a wavelet transform is used to directly compute the gradient for at least one layer of an object under inspection, rather than first tomosynthetically reconstructing a full image of the depth layer and using the reconstructed image to compute the gradient. The gradient that is computed directly from the wavelet transform may be used to identify a layer that includes an in-focus view of a feature of interest. Thus, this embodiment is computationally efficient in that the gradient of one or more depth layers in which a feature of interest may potentially reside may be computed and used for performing auto-focusing to determine the depth layer that includes an in-focus view of the feature of interest without requiring that the depth layers first be tomosynthetically reconstructed. Further, by using lower resolution image data to identify when and where higher resolution data is needed, unnecessary processing of higher resolution image data can be avoided.

In the embodiment of the system 100 shown in FIG. 1, the wavelet transform comprises gradient-based image data at a plurality of different resolutions. A hierarchical auto-focusing technique may be used in which the gradient-based image data having a first (e.g., relatively coarse) resolution may be used to evaluate at least certain ones of a plurality of depth layers in which a feature of interest may potentially reside to determine a region of layers in which an in-focus view of the feature of interest resides. Thereafter, the gradient-based image data having a finer resolution may be used to evaluate at least certain ones of the depth layers within the determined region to further focus in on a layer in which an in-focus view of the feature of interest resides. Further, accuracy and reliability calculations can be used to identify the most appropriate level of resolution.

In the embodiment of FIG. 1, an imaging system 102, is used to capture image data 104. For instance, source 20 of imaging system 102 projects X-rays toward an object 10 that is under inspection, and detector array 30 captures the image data 104.

In the embodiment shown in FIG. 1, the detector image data 104 is processed by a wavelet transform module 106, which uses a wavelet transform, such as the well-known 2D Haar wavelet transform, to calculate sharpness values for an auto-focus curve. Wavelet transform module 106 processes detector image data 104 to provide a representation of the image data at multiple different resolutions. More specifically, wavelet transform module 106 transforms image data 104 into gradient-based image data at a plurality of different resolutions, such as low-resolution gradient-based image data 108, higher-resolution gradient-based image data 110, and even high-resolution gradient-based image data 112. In this example, low-resolution gradient-based image data 108 is one-eighth (⅛) the resolution of detector image data; higher-resolution gradient-based image data 110 is one-fourth (¼) the resolution of detector image 104; and even higher-resolution gradient-based image data 112 is one-half (½) the resolution of detector image data 104.

In this manner, the result of processing the image data 104 with wavelet transform 106 provides gradient-based information in a hierarchy of resolutions. An embodiment of the present invention may use this hierarchy of resolutions of gradient-based image data to perform the auto-focusing operation. For instance, in the embodiment 100 of FIG. 1, any of 33 different depth layers 101 (numbered 0-32 in FIG. 1) of the object 10 under inspection may include an in-focus view of a feature that is of interest. That is, the specific location of the depth layer that includes the feature of interest is unknown. Suppose, for example, that the top surface of object 10 is of interest (e.g., for an inspection application). From the setup of the imaging system, the inspector may know approximately where that surface is (in the “Z” height dimension). In other words, the top surface of object 10 is expected to be found within some range DELTA-Z. That range DELTA-Z is subdivided into several layers (e.g., the 32 layers 101 in FIG. 1), and the auto-focus algorithm is run on those layers 101 to identify the sharpest layer (the layer providing the sharpest image of the top surface of object 10 in this example). The number of layers may be empirically defined for a given application, and is thus not limited to the example number of layers 101 shown in FIG. 1.

As shown in the example of FIG. 1, the low-resolution gradient-based image data 108 is used to reconstruct the gradient of every eighth one of layers 101. Thus, tomosynthesis is performed using the gradient-based image data 108 to reconstruct the gradient of layers 0, 8, 16, 24, and 32. Those reconstructed layers are evaluated (e.g., for sharpness and/or other characteristics) to determine the layer that provides a most in-focus view of a feature of interest. For instance, the sharpness of those layers may be measured (by analyzing their reconstructed gradients), and the layer having the maximum sharpness may be determined. In the example of FIG. 1, layer 8 is determined as having the maximum sharpness.

It should be recognized that the gradients of layers 0, 8, 16, 24, and 32 are reconstructed directly from the relatively low-resolution image data 108 of the wavelet transform 106. Thus, the computational cost of reconstructing the gradient of such layers 0, 8, 16, 24, and 32 directly from this low-resolution data 108 is much less than first tomosynthetically reconstructing a cross-sectional image from the captured image data 104 and then computing the gradient from such reconstructed cross-sectional image. The process of identifying the one layer out of every eighth layer of layers 101 that is closest to (or is most nearly) the layer of interest (e.g., the sharpest layer) may be referred to as the first level of the hierarchical auto-focusing technique.

Once the layer of the first level of the hierarchical auto-focusing technique that has the maximum sharpness is determined (layer 8 in the example of FIG. 1), the wavelet transform data having the next highest resolution may be used to further focus in on the layer of interest. For instance, as shown in the example of FIG. 1, the higher-resolution gradient-based image data 110 is used to reconstruct the gradients of certain layers around the initially identified layer 8 to further focus in on the layer of interest. In this example, the gradient-based image data 110 is used for reconstructing the gradient of layer 8, which was identified in the first level of the hierarchical auto-focusing technique as being nearest the layer of interest, and the gradient-based image data 110 is also used for reconstructing the gradients of layers 4 and 12. That is, tomosynthesis is performed using the gradient-based image data 110 (which is the next highest resolution gradient-based data in the hierarchy of resolution data of the wavelet transform) to reconstruct the gradients of layers 4, 8, and 12. The reconstructed gradients of layers 4, 8, and 12 are evaluated (e.g., for sharpness and/or other characteristics) to determine the layer that provides the most in-focus view of a feature of object 10 that is of interest. In the example of FIG. 1, layer 4 is determined as having the maximum sharpness.

It should be recognized that the gradients of layers 4, 8, and 12 are reconstructed directly from the gradient-based image data 110 of the wavelet transform 106. Thus, the computational cost of reconstructing the gradient of such layers 4, 8, and 12 directly from this data 110 is much less than first tomosynthetically reconstructing a cross-sectional image from the captured image data 104 and then computing the gradient from such reconstructed cross-sectional image. The process of identifying the one layer out of layers 4, 8, and 12 of layers 101 that is closest to (or is most nearly) the layer of interest (e.g., the sharpest layer) may be referred to as the second level of the hierarchical auto-focusing technique.

Once the layer of the second level of the hierarchical auto-focusing technique having the maximum sharpness is determined from analysis of the reconstructed gradients using gradient-based image data 110 (layer 4 in the example of FIG. 1), the wavelet transform data having the next highest resolution may be used to further focus in on the layer of interest. For instance, as shown in the example of FIG. 1, the higher-resolution gradient-based image data 112 is used to reconstruct the gradient of certain layers around the identified layer 4 to further focus in on the layer of interest. In this example, the gradient-based image data 112 is used for reconstructing the gradient of layer 4, which was identified in the second level of the hierarchical auto-focusing technique as being nearest the layer of interest, and the gradient-based image data 112 is also used for reconstructing the gradient of layers 2 and 6. That is, tomosynthesis is performed using the gradient-based image data 112 (which is the next highest resolution gradient-based data in the hierarchy of resolution data of the wavelet transform) to reconstruct the gradients of layers 2, 4, and 6. Those layers are evaluated by the auto-focusing application (e.g., for sharpness and/or other characteristics) to determine the layer that provides the most in-focus view of a feature of object 10 that is of interest. For instance, the sharpness of those layers may again be measured by the auto-focusing application (using their reconstructed gradients), and the layer having the maximum sharpness may be determined. In the example of FIG. 1, it is determined that layer 4 is the layer of interest (i.e., is the layer having the maximum sharpness).

It should be recognized that in the above example auto-focusing process of FIG. 1, the gradient of layers 2, 4, and 6 are reconstructed from the gradient-based image data 112 of the wavelet transform 106. Thus, the computational cost of reconstructing the gradient of such layers 2, 4, and 6 directly from this data 112 is much less than first tomosynthetically reconstructing a cross-sectional image from the captured detector image 104 and then computing the gradient from such reconstructed cross-sectional image. The process of identifying the one layer out of layers 2, 4, and 6 of layers 600 that is closest to (or is most nearly) the layer of interest (e.g., the sharpest layer) may be referred to as the third level of the hierarchical auto-focusing technique.

Any number of depth layers 101 may be evaluated by the auto-focusing application in alternative implementations, and any number of levels of processing may be included in the hierarchy in alternative implementations (and thus are not limited solely to the example of three levels of hierarchical processing described with FIG. 1). Also, while an example hierarchical auto-focusing process is described with FIG. 1, it should be recognized that other embodiments of the present invention may not utilize such a hierarchical technique. For instance, certain alternative embodiments of the present invention may use gradient-based image data from wavelet transform 112 (e.g., higher-resolution gradient-based image data 112) to reconstruct (or compute) the gradient for every one of layers 101, and such gradients may be evaluated to determine the layer of interest (e.g., the layer that provides the most in-focus view of a feature of object 10 that is of interest). Because the gradients of such layers are reconstructed directly from wavelet transform 106 without requiring that those layers first be tomosynthetically reconstructed, these alternative embodiments may also be more computationally efficient than traditional auto-focusing techniques.

Control module 105 is provided to further refine the hierarchical auto-focus process. The control module 105 can include the functions described in more detail below, which include determining accuracy confidence limits, and reliability scores for different resolution levels. The control module 105 can operate to analyze image data to determine high and low frequency noise qualities in the image data. The control module can also control the wavelet transformation process, to determine which level of resolution is most appropriate, for a given imaging situation.

In embodiment 100 the control module 105, and the wavelet transform module 106 could be implemented in computer, and these modules could be implemented in a processor which are programmed to perform the functions described herein. Further, the computer system could also include a display and the processor would also be programmed to perform the generation of images to be shown to a user of the system on the display. The processor of the computer could generate the image at selected height levels in the object, and to generate the image such that the image shows at least a part of the object being inspected. The functions herein could be implemented using a single processor, or using multiple processors.

An embodiment herein provides for constructing confidence measures for the parameters, or data, extracted from sharpness profiles (gradient data) obtained from wavelet transformation or other technique, during auto-focusing, and provides for using this confidence information as a basis for determining the reliability and accuracy of estimates at different resolution levels. Additionally, an embodiment herein can use the confidence information to identify a resolution level that is considered adequate (thus terminating the algorithm) prior to consuming unnecessary processing time associated with going to higher resolution levels.

An embodiment of a method herein provides that the noise in the sharpness profile is divided into high and low frequency qualities and analyzed. The high frequency qualities may be estimated in advance, and is used to define accuracy confidence limits, by comparing the actual image data to a model that has been fit to the data. The model may be used to extract features from the curve, such as peak location and width, edge locations, etc. Low frequency noise is tracked during run-time using carefully selected sample points, and leads to a reliability score for the results, i.e. how much the peak rises above the noise floor. These two measures: accuracy and reliability, may be used to choose which resolution level will be used during auto-focusing.

### Determining High Frequency Noise

In one embodiment a first step in the method is to identify a high frequency noise quality, which is primarily due to the characteristics of the imaging system. The image-capture system, image artifacts, or shadows may all contribute to the high frequency noise. The part of noise that is indeed due to the imaging system can be measured in advance, of actual runtime operation where image data is being gathered for an object. This ability to obtain high frequency noise information in advance of actually obtaining image information for an object can be beneficial, since the high frequency noise can be very difficult to measure at run-time due to operational speed requirements, where one may need to acquire the image data for an object in a very short amount of time. Of course it should be recognized that an alternative embodiment could operate to obtain high frequency noise information at runtime, but generally such embodiments would be computationally very expensive.

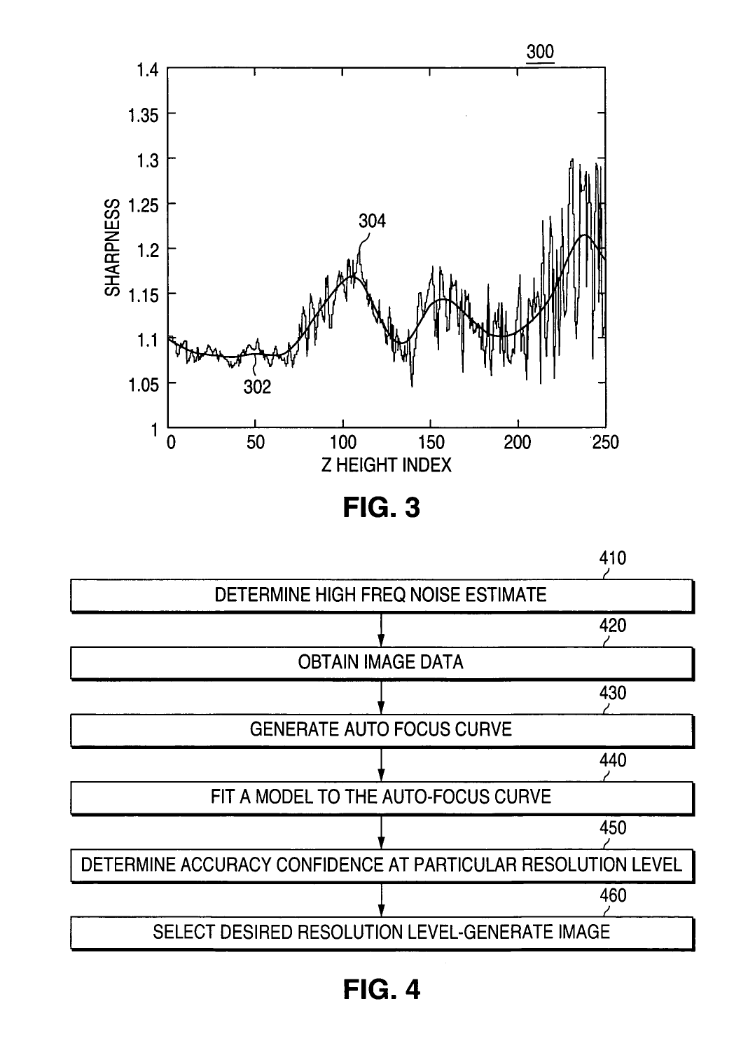

There are many techniques for estimating the noise of a signal. A simple method is to first construct a smooth version of the signal, and then subtract it from the original. This is a reasonable approach for finding high frequency noise. Smoothing-splines are an example of a well-known method for computing a smooth version of a signal. FIG. 3 shows a graph 300 with an example of a sharpness profile curve 304 for a particular object, and a smoothed version 302. This figure makes it easy to see the high frequency component of the signal.

There are several metrics for computing the noise value. For example, the Root Mean Square (RMS) measure,

$${σ}_{rms} = \sqrt{\frac{1}{N} {\sum }_{i = 1}^{N} ( {S}_{i} - {s}_{i}^{′} )}$$

and also the median error,
σₘ=Med(|S−s′|)
are well known, and widely used. (In these equations, S is the vector of sharpness values, and s′ is the vector of smoothed sharpness values). These measures can be done for each resolution level, and for a variety of datasets, to determine a high frequency noise value.

### Fitting a Good Model

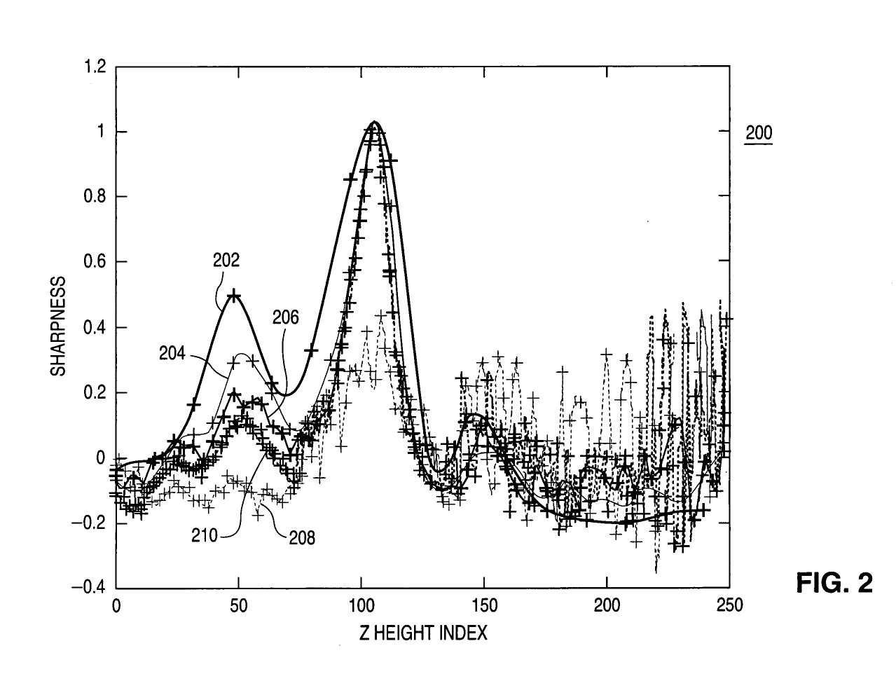

In one embodiment a second step in the method is to fit a model to the sharpness profile. The data in FIG. 2, for example, closely resembles a Gaussian function, suggesting this is a good model for that dataset. More details regarding FIG. 2 are discussed below, but in general FIG. 2 shows multiple sharpness profiles for different resolution levels. These sharpness profiles, area also referred to herein as auto-focus curves, and can be obtained using a wavelet transformation of image data as discussed above. In one embodiment the sharpness profile shows the height −Z at which the features of most interest are most likely to present in an object being imaged. Each of the auto-focus curves 202-208 shows a main peak at a z-height of slightly more than 100 on the height index. This main peak corresponds to height in the object which is identified as having a highest sharpness value. Many methods for fitting models exist, such as the Levenberg-Marquardt method, which is a robust iterative method for non-linear fitting. Deeply connected to the model is an associated measure for goodness-of-fit. This measure quantifies how well the model fits the dataset, given whatever prior knowledge exists about the data and what constraints are imposed on the model. It also tests for convergence. If the noise and/or measurement error σ in a system is normally distributed, then the maximum likelihood estimate of the model parameters can be obtained by minimizing the chi-squared statistic, where chi-squared is shown by the equation below:

$${X}^{2} ( a ) = {\sum }_{i} {( \frac{{y}_{i} - f ( {x}_{i} , a )}{{σ}_{i}} )}^{2}$$

This statistic is essentially a weighted least squares measure for goodness-of-fit. To compute values using this formula, the noise value σ is pre-computed, for example using a method as described above, or an alternative method for computing such a noise values could be employed. For the simple case of one parameter, it has been shown (for example see Press, Flannery, Teukolsky, Vetterling “numerical Recipes in C”, 1998, Cambridge University Press, which is incorporated herein by reference) that a confidence interval can be represented by:
δα₁=±\sqrt{Δχᵥ²}\sqrt{C₁₁}
where δα₁ is the first model parameter, and C₁₁ is the upper-left term of the covariance matrix (computed during the fitting algorithm).

The parameter δα is fundamental to assessing the value of the curve fit at each resolution level. It describes the relative accuracy with which a particular feature of interest is known. It should be noted that this score provides a relative accuracy measure in that it provides a measure to characterize how accurately different model parameters can be calculated. Thus, the term accuracy as used herein is generally meant to refer to the relative accuracy with which a model can be determined, as opposed to an absolute accuracy which would pertain to a calibration or measure of operation of the system. The parameter δα can be computed separately for all of the model parameters, leading to confidence intervals for each feature of interest. For example, if the algorithm search is for sharpest layer (which in one embodiment would correspond to a main peak in the auto-focus curve) the parameter of interest is the mean of the Gaussian curve. The confidence interval for the mean describes the accuracy that can be expected from the estimation of sharpest layer. This value can be compared across resolution levels to determine which level has the highest confidence (or the smallest confidence interval). Similar comparisons may be done with other curve parameters, such as inflection points, half-width-half-max points, edges, peak width, etc.

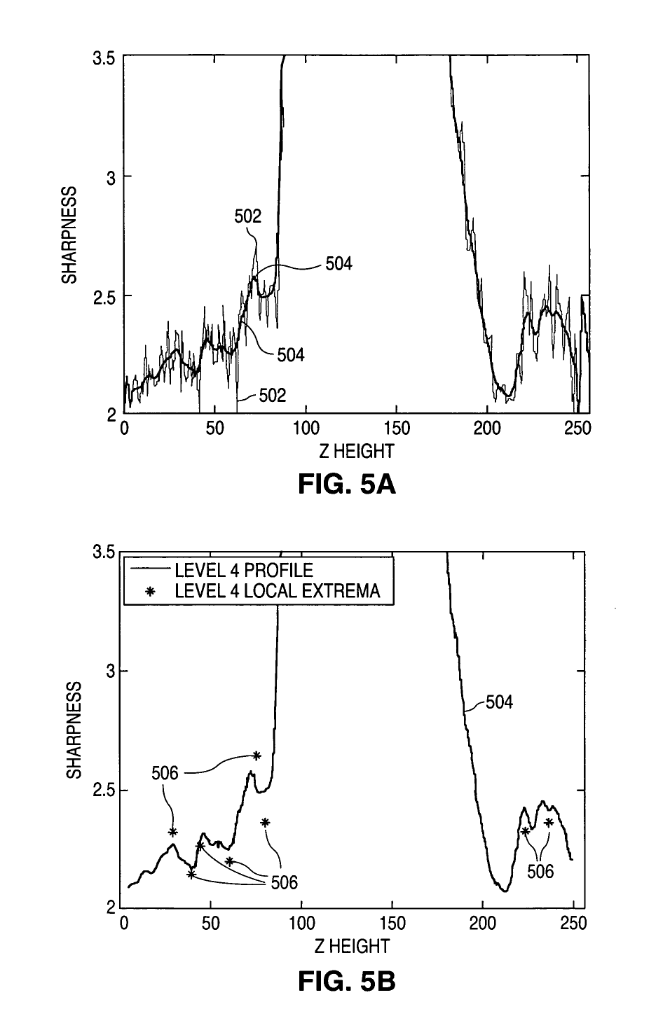

FIG. 4 is flow chart illustrating a method 400 of an embodiment herein. The method shown generally corresponds to the operations described above. The method includes determining 410 an estimated high frequency noise quality. The high frequency noise can be determined in advance of actual run time operation of the imaging system, wherein during runtime a particular object is being imaged using the imaging system. The method also includes actually obtaining 420 image data. This can be done using an imaging system as described in connection with FIG. 1. Once the image data has been obtained, auto-focus curves can be generated 430, using wavelet transformation or other methods. A model is then fit 440 to the auto-focus curve. The accuracy confidence at a particular resolution level, or for multiple resolution levels is then determined 450. A resolution level is then selected 460 based on the determined accuracy confidence levels corresponding to different resolution levels, and a complete image can be generated based on the selected resolution level. It should be noted that once a resolution level has been selected a number of different mathematical image generation techniques could be used to generate an image at the desired resolution level. One technique is tomosynthesis, but other methods of tomography, for example, could also be used.

Measure of Low Frequency Noise

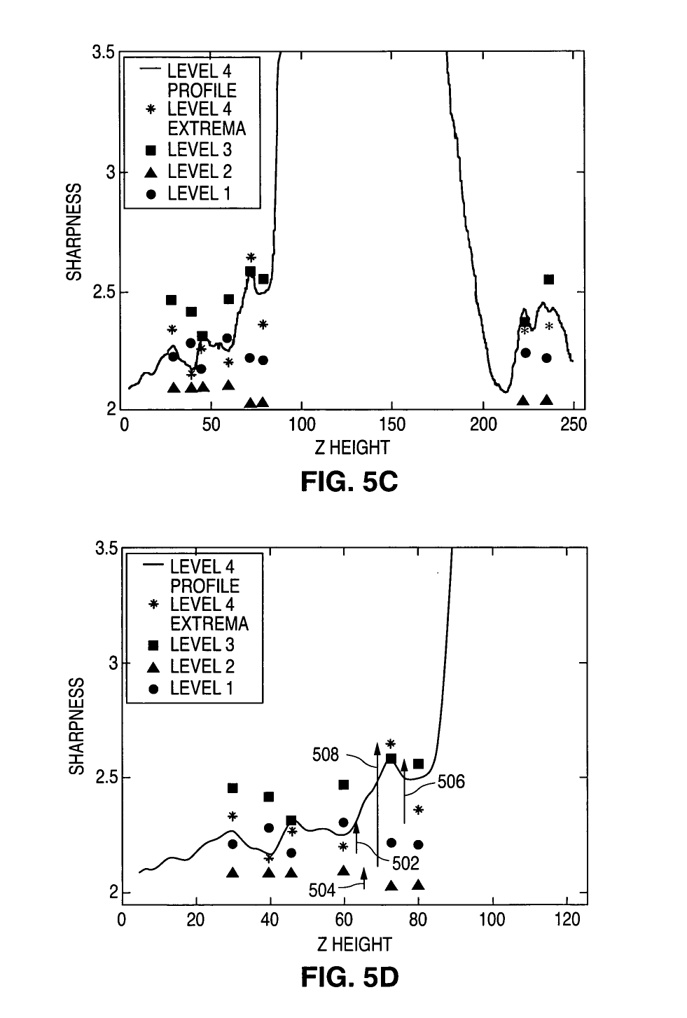

Image artifacts or shadows are the primary contributors to low frequency noise. An embodiment herein allows for determination of low frequency noise during actual runtime operation of the system, and uses image data obtained while an object under test is being imaged. In other embodiments it may be possible to provide for computing the low frequency noise prior to actual runtime operation of the system. In one embodiment herein, runtime determination of low frequency noise is achieved by utilizing the fact that in many instances the locations of artifacts are relatively constant between resolution levels. The artifact in FIG. 2 for example, located near z=50 shows up consistently at each level. A method for measuring these artifacts, at each resolution level, is illustrated in FIGS. 5A-5D.

FIG. 5A shows a sharpness profile 502 (auto-focus curve) at the coarsest resolution (which is computationally cheap), and a smoothed sharpness profile 504, using an appropriate smoother such as moving average or smoothing splines. FIG. 5B shows the identification of a plurality of local extrema (local extreme points) that lie outside the main peak of the smoothed profile. FIG. 5C shows a sharpness calculation at the identified local extreme points for four different levels of resolution, where level 4 is the lowest resolution level and level 1 is the highest resolution level. At each resolution level, the method provides for estimating the magnitude of the artifact noise by subtracting the largest sharpness value of the local extrema from the smallest sharpness value of the local extrema for a given resolution level. This is shown in FIG. 5D, where arrow 502 corresponds to level 1; arrow 504 corresponds to level 2; arrow 506 corresponds to level 3; and arrow 508 corresponds to level 4; as illustrated in FIG. 5D.

Using these steps, the amplitude and location of various image artifacts (low frequency noise) can be tracked during run-time. In the final step, we use these artifacts (low frequency) peaks to define a signal-to-noise ratio:

$$γ = \frac{{P}_{max} - {S}_{min}}{{S}_{max} - {S}_{min}}$$

where Pₘₐₓ is the max value of the main peak, Sₘₐₓ is the max value of the artifact extrema, and Sₘᵢₙ is the min value of the artifact extrema. The parameter γ now represents how tall a particular sharpness peak stands above the noise peaks, and in one embodiment provides a reliability score. As such, this measure can be used as a reliability score. For example, when a sharpness peak is much larger than the artifact peaks, we have a high degree of confidence in the reliability of this measurement. Thus, the reliability score provides a data confidence measure. On the other hand, if the sharpness peak magnitude is only on the same order as the artifact peaks, then we have less confidence in its reliability. This measure can be compared on different resolution levels to estimate the reliability of each profile.

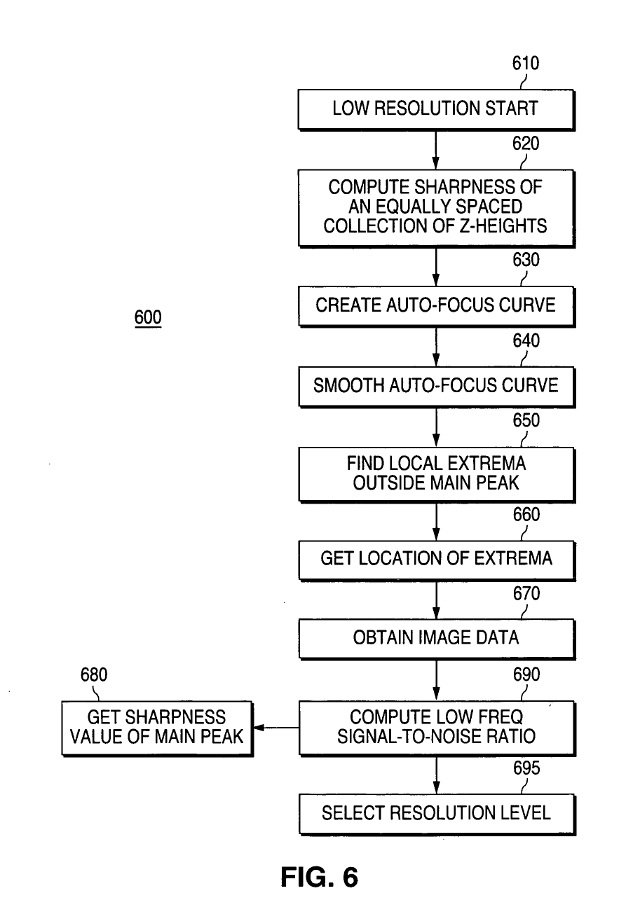

A summary of the methods of an embodiment herein used to compute the reliability score, as related to the low frequency noise is illustrated in the flowchart 600 in FIG. 6. Initially a relatively low resolution for the image data is selected 610 for processing. This selection of a low resolution could be as simple as merely selecting the coarsest resolution provided for the system. Using the low resolution image data, sharpness is computed 620 for each of an equally spaced collection of z-heights. (In one embodiment this would correspond to using a wavelet transform to generate an auto-focus curve.) Using the sharpness calculations for each of the different z-heights an auto-focus curve is generated 630. The auto-focus curve is then smoothed 640. A plurality of local extreme points outside of the main peak of the auto-focus curve are then identified 650. The identified local extreme points can then be determined 660 in terms of z-height for the local extreme points. At a variety of different higher resolutions, the sharpness is computed 670 at the identified plurality of local extreme points. The sharpness of the main peak is determined at 680. The low frequency signal to noise ratio is calculated 690 and the reliability score is determined. The reliability score can then be used to select a desired resolution level for satisfactory image 695.

Combining Accuracy and Reliability Procedures

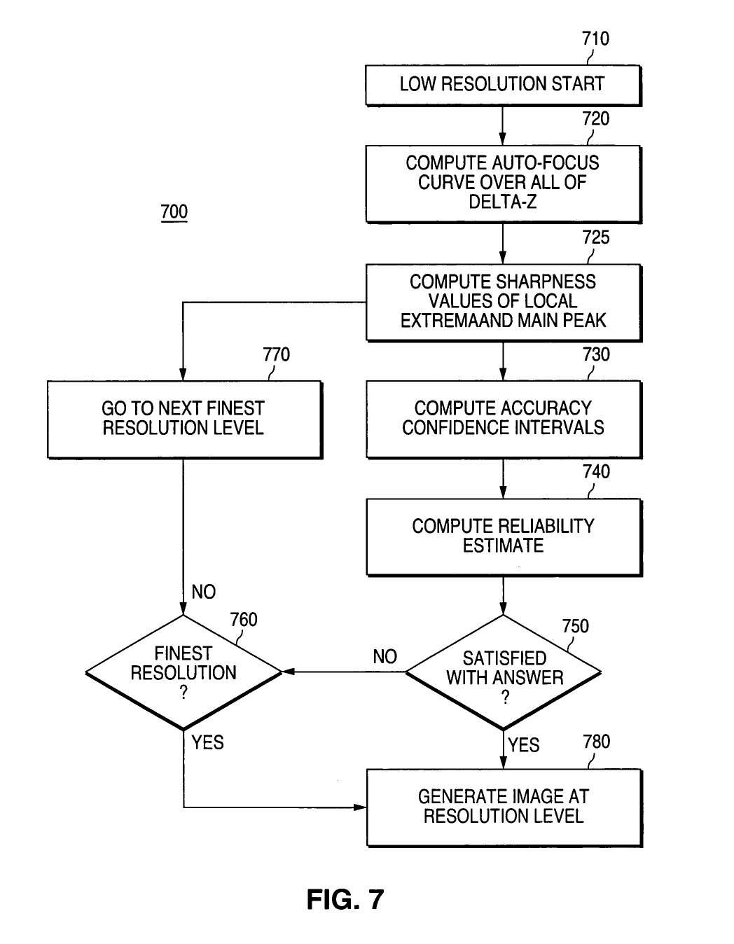

The above discussion provides for two different measures of data which can be used in combination to characterize the accuracy and reliability of image data at different resolutions. FIG. 7 shows a flow chart of an embodiment of a method 700 herein which combines reliability and accuracy calculations. In the method 700 the combining of the accuracy confidence measure and the reliability score, includes starting with relatively low resolution image data 710. Based on the low resolution image data generating an auto focus curve 720 spanning the region delta-Z, so that local extreme points outside of the main peak of the auto-focus can be identified. The evaluation of sharpness values at the locations of the main peak, and the location of local extrema is the performed 725. The method includes computing an accuracy confidence levels for different resolution levels 730, and computing 740 a reliability estimate. The reliability and accuracy confidence computations are analyzed 750 to determine if the low resolution image data provides sufficiently accurate and reliable results; for example predetermined thresholds can be set to make this determination. If the results are not satisfactory then a determination 760 is made as to whether a higher resolution is available. If a higher resolution of image data is available, then the method uses the next finest resolution level 770, and proceed with computing the auto-focus for the next finest resolution level. If the reliability and accuracy confidence results are satisfactory, then the process concludes 780 with using the image data for the corresponding resolution level to generate and display an image at the corresponding resolution level, or if no finer resolution is available, then the process concludes 780 with using the image data for the corresponding resolution level or using the level with the highest confidence results.

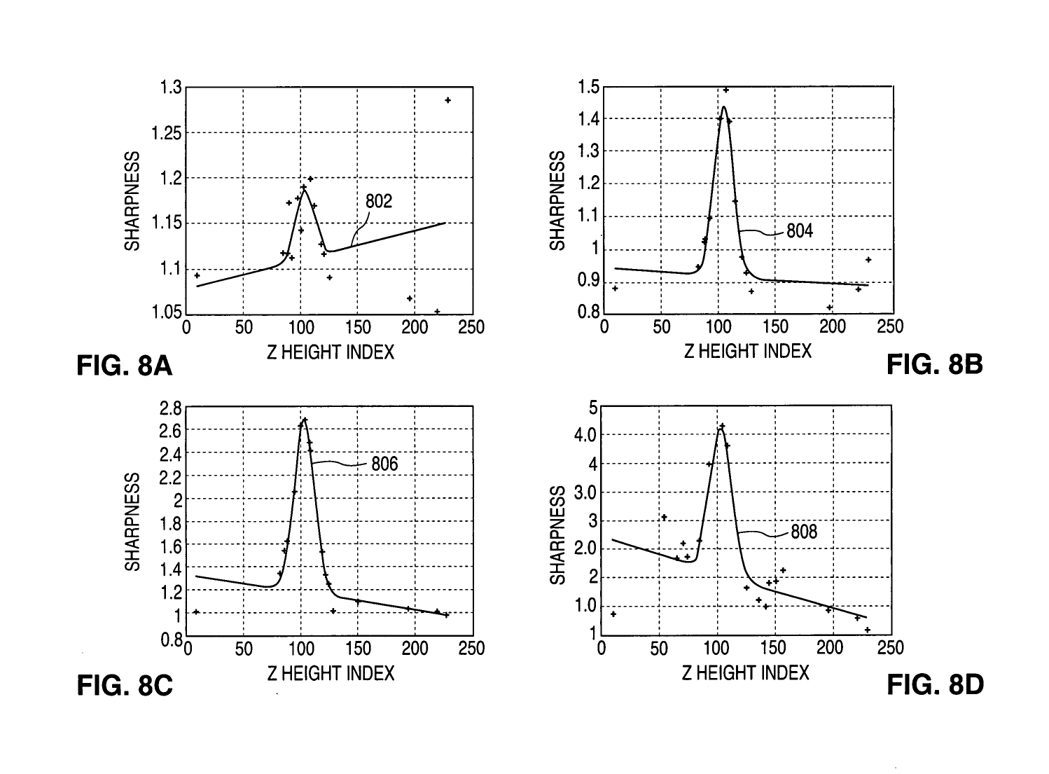

Referring to the auto-focus curves shown in FIG. 2 an example of the operation of an embodiment herein can be illustrated. Each of the sharpness curves 202-208 were modeled using a base-lined Gaussian function, shown below:

$$f = a + b \cdot x + c \cdot exp ( \frac{- {( x - μ )}^{2}}{2 {σ}^{2}} )$$

where a +bx is a linear baseline, μ is the mean of the Gaussian, and σ is the standard deviation (this is not the noise value, which also used the symbol σ above). The mean μ, is the location of the sharpest layer, and σ is used for edge location. The sample points found to track the low frequency artifacts are z=[10,50,150,195,220,228]. At each level of resolution the sharpness is computed at the sample point locations, and at a series of unequally spaced points in the main peak. The Gaussian function was fit to the data using Levenberg-Marquardt. In FIGS. 8A-8D, the fit is shown for each of the resolution levels where Gaussian curve 802 corresponds to the data for resolution level 1; Gaussian curve 804 corresponds to the data for resolution level 2; Gaussian curve 806 corresponds to the data for resolution level 3; Gaussian curve 808 corresponds to the data for resolution level 4.

Table 1 shows the parameters obtained at each resolution level corresponding to the auto-focus curves 202, 204, 206 and 208 shown in FIG. 2. In FIG. 2 auto-focus curve 202 is the lowest resolution level as is indicated by the height difference between adjoining hatch marks + which correspond to image data points. The highest resolution auto-focus curve pertinent to this discussion is curve 208 which has a much closer interval between data points along the z height axis is shown. It should be noted that curve 210 corresponds to different technique for determining sharpness, the Sobel technique, where generally even higher resolution image data is required to determine the auto-focus curve. (Curve 210 is provided for reference purposes.) Table 1 below shows parameters for the different auto-focus curves; these parameters for the different resolution levels show their associated accuracy confidence limits, and their reliability score (small accuracy limits are good, large reliability scores are good).

| Res.level | | | | | | |
|---|---|---|---|---|---|---|
| (aut. | | | Standard | +/−standard | Reliability | Overall |
| Curve) | Sharpest Z | +/−sharpest | dev. | dev | score | score |
| 1 (202) | 109.58 | 8.04 | 8.19 | 9.32 | 0.62 | 0.08 |
| 2 (204) | 105.12 | 1.23 | 8.02 | 1.42 | 3.72 | 3.02 |
| 3 (206) | 104.06 | 1.3 | 9.15 | 1.52 | 2.72 | 2.09 |
| 4 (208) | 105.73 | 3.24 | 9.45 | 4.01 | 1.84 | .057 |

Column 2, Sharpest Z, shows the height in object being viewed is determined as having the sharpest features according to the corresponding auto-focus curve. Column 3, +/± sharpest, shows the calculated accuracy confidence limit which corresponds to the δα₁ calculation, described above, in connection with determining the accuracy confidence limit. Column 4, Standard dev., generally corresponds to the width of the peak of the corresponding auto-focus curve around the main peak or maximum of the auto-focus curve, or more precisely this value corresponds to the standard deviation of the Gaussian model. Column 5, +/± standard dev., corresponds to the confidence level of the standard deviation from col. 4. Column 6 corresponds to a reliability score, obtained using the reliability calculation discussed above.

It should also be noted that an embodiment herein could further provide an overall characteristic score, which combines both the accuracy confidence limit of column 3 for the above table with the reliability score of column 6 in the above table. For example, one embodiment herein can use an equation to calculate an overall reliability score “s”, where s is provided as the ratio of the reliability score to the relative accuracy. Thus, the overall score would be given by

$$s = \frac{γ}{{δ}_{a}}$$

where δα is the model parameter confidence measure (accuracy) for the various model parameters, and γ is the reliability score. Using the overall score “s” the metrics of Table 1 can be combined to provide overall scores for the different resolution levels. Column 7 of the above table shows an overall score “s” for each of the corresponding resolution levels.

Another way to combine the scores would be to use a weighted average, along the lines of:

$$s = {k}_{1} + γ \frac{{k}_{2}}{{δ}_{a}}$$

and as one skill in the art will recognize a range of other equations and processes could be used to provide for combining the reliability score and the accuracy determinations to provide an overall score.

Although only specific embodiments of the present invention are shown and described herein, the invention is not to be limited by these embodiments. Rather, the scope of the invention is to be defined by these descriptions taken together with the attached claims and their equivalents.

What is claimed is:

1. In a system for generating an image of at least a portion of an object, a method comprising:
capturing image data for at least a portion of the object;
identifying a low frequency noise quality in the captured image data for at least a portion of the object; and
using the low frequency noise quality to select a resolution level for generating an image using the captured image data.

2. The method of claim 1, wherein the identifying a low frequency noise quality includes using the captured image data to generate an auto-focus curve for a first resolution level, and identifying local extreme points corresponding to a plurality of different heights in the object, where the local extreme points lie outside of a main peak of the auto-focus curve.

3. The method of claim 2, wherein the auto-focus curve is generated using a wavelet transform, and reflects a sharpness quality of the image data for the first resolution level.

4. The method of claim 2, further including calculating a sharpness value, using a second resolution level of the image data, for each of the plurality of different heights in the object.

5. The method of claim 4, wherein the calculating a sharpness value, using a second resolution level of image data is done using a wavelet transform operation.

6. The method of claim 1, further wherein the image of at least a portion of the object is generated using digital tomosynthesis.

7. The method of claim 1 further including:
identifying a high frequency noise quality for the captured image data;
using the high frequency noise quality and the low frequency noise quality to select a resolution for generating an image using the captured image data.

8. The method of claim 7, wherein the high frequency noise quality is captured prior to a runtime operation of the system, wherein image data for the object is being captured during the runtime operation of the system.

9. The method of claim 1, wherein the low frequency noise quality is used to determine a reliability score for the captured image data for a given resolution level.

10. The method of claim 7, wherein the low frequency noise quality is used to determine a reliability score for the captured image data for a given resolution level, and the high frequency noise quality is used to determine an accuracy confidence level for the given resolution level.

11. In an imaging system, a method for evaluating a quality of different resolution levels for viewing at least a portion of an object, the method comprising:
using image data to generate an auto-focus curve for a plurality of different resolution levels, wherein the auto-focus curves provide an estimate for a sharpest height in the object;
determining a high frequency noise quality for each of the plurality of resolution levels;
determining a low frequency noise quality for each of the plurality of different resolution levels; and
using the high frequency noise quality for each of the plurality of different resolution levels, and the low frequency noise quality for the plurality of different resolution levels to select a resolution level for generating an image of at least a portion of the object.

12. The method of claim 11, further including using the high frequency noise quality for each of the plurality of different resolution levels to determine an accuracy measure for a sharpest layer estimate in the object.

13. The method of claim 11, further including using the low frequency noise quality to determine a reliability for each of the plurality of different resolution levels.

14. The method of claim 11, wherein the auto-focus curves are generated using a wavelet transform to calculate sharpness quality using the image data.

15. The method of claim 11, wherein the image of at least a portion of the object is generated using digital tomosynthesis.

16. The method of claim 11 further including wherein determining a low frequency noise quality includes identifying local extreme points of a first auto-focus curve of the plurality of auto-focus curves, wherein the local extreme points lie outside of a main peak of the first auto-focus curve, and correspond to a plurality of different heights in the object, and wherein the first auto-focus curve is generated from a first resolution of the image data, and the local extreme points for the first auto-focus curve have associated sharpness values.

17. The method of claim 16, further, including determining sharpness values for a second resolution of the image data, at the plurality of different heights in the object, and using the sharpness values for the second resolution image data, and the sharpness values for the local extreme points identified using the first auto-focus curve to determine whether the first resolution image data or the second resolution image data has a higher reliability.

18. The method of claim 12, wherein the first resolution level is less that the second resolution level.

19. A system for generating an image of at least a portion of an object, the system including:
an imaging system which captures image data for at least a portion of an object;
a multi-resolution transform module for generating auto-focus curves based in the captured image data;
control module which determines a high frequency noise quality for the imaging system and determines a low frequency noise quality based on the captured image data, and wherein the control module is operable to select a resolution level for an image to be generated using the captured image data.

20. In a system for generating an image of at least a portion of an object, a method comprising:
identifying a high frequency noise quality for the system;
capturing image data for at least a portion of the object; and
using the high frequency noise quality to select a resolution for generating an image using the captured image data.

21. The method of claim 20, wherein the high frequency noise quality is identified prior to a runtime operation of the system, and wherein image data for the object is captured during the runtime operation of the system.
